(19) United States
(12) Patent Application Publication
(10) Pub. No.: US 2012/0237740 A1
(43) Pub. Date: Sep. 20, 2012

(54) PRINTING AND PIGMENTATION USING QUANTUM DOT NANOPARTICLES

(76) Inventors: Robert C. Hefty, Laguna Niguel, CA (US); Emily J. Hefty, Laguna Niguel, CA (US)

(21) Appl. No.: 13/419,160

(22) Filed: Mar. 13, 2012

Related U.S. Application Data
(60) Provisional application No. 61/454,140, filed on Mar. 18, 2011.

(51) Int. Cl. D06P 5/28; B05D 7/00; B32B 3/10; B05D 5/00; D06P 1/00; B82Y 40/00; B82Y 30/00

(52) U.S. Cl. 428/196; 427/256; 427/288; 8/471; 8/636; 428/207; 977/774; 977/773; 977/961; 977/788

(57) ABSTRACT

A process including article of manufacture, utilizes nanoparticles, such as quantum dots, as pigment or dye-pigment to color an article, via dye-sublimation, printing, coloring, or painting methods. Garments or decorative media are manufactured utilizing these methods to incorporate nanoparticles as coloring agents.

### CROSS REFERENCE TO RELATED APPLICATIONS

The present patent application is a formalization of a previously filed co-pending provisional patent application entitled “Dye Sublimation Process Utilizing Nanoparticles,” filed Mar. 18, 2011, as U.S. patent application Ser. No. 61/454,140 by the inventor(s) named in this application. This patent application claims the benefit of the filing date of the cited provisional patent application according to the statutes and rules governing provisional patent applications, particularly 35 USC §119 and 37 CFR §1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a process, including article of manufacture, for coloring an article utilizing nanoparticles. In particular, nanoparticles, such as quantum dots, are used as pigment or dye-pigment to color an article, via dye-sublimation, printing, coloring, or painting methods.

### BACKGROUND

Quantum dots (aka nanoparticles, nano particles, nanodots, nanocrystals, Q-dots, etc.) have a unique physical property because of the physical size of the dots. The term quantum dot or nanoparticle can be applied to any inorganic, carbon based, or metallic composition that is formed at a size whereby certain physical properties determine the response of the particle to excitation by either photo- or electro-excitation. In particular, the invention described here is related to the case whereby the light emitted from the nanoparticle is determined not exclusively by the band gap or energy levels of the bulk material itself used to make the particle, but rather by the size of the particle itself. A particle, made up of a given semiconductor, organic, or metallic material, may emit light at different wavelengths, which are tunable by adjusting the size of the particle, while keeping the chemical makeup of the particle constant. This feature of size-based tunability of emitted light allows for precise control of the wavelength through either a photoluminescent or electroluminescent fluorescence of phosphorescence. The tunability of wavelength for several materials has been well documented.

The invention claimed here pertains to the use of these quantum dots or nanoparticles as a pigment for use in decorated media, art, marketing collateral, or any other dyed, printed, or painted form. The material composition may be metallic, inorganic, or organic, possibly consisting of, but not limited to, CdSe, CdS, CdTeSe, TeSe, InP, C, Si, SiO2, Si3N4, InGaN, GaN, Au, Ag, etc. The nanoparticles may be incorporated as a dye or pigment either directly as individual particles, or as incorporated into a carrier matrix, which may be formed by any polymer, inorganic, organic, or metallic substrate. Examples of a carrier matrix may be SiO2, Si3N4, Au, Ag, carbon nanotubes, poly vinyl chloride, PEG, PMMA, plastisol, or any other polymeric substrate used for screen or document printing or for dye sublimation or thermal sublimation printing. The nanoparticles may be incorporated into the carrier matrix either homogeneously or heterogeneously. They may be either added onto the surfaces of pre-existing particles of the carrier or incorporated into the bulk matrix and converted into particles to be used for pigmentation at a later time. The pigmented mixture or pure pigment nanoparticles are then applied to a surface and permanently attached to the target media, which could be any polyester, cotton, or other material used for clothing or other fashion accessories, metal, ceramic, wood, glass, or any other material that can be typically painted or dyed with standard pre-existing paints and dyes.

### SUMMARY

In one aspect, a method for coloring an article is disclosed which includes using nanoparticles pigment or dye-pigment as a coloring agent, depositing a pattern of them on a transfer substrate, drying the substrate, positioning the transfer substrate on a surface of the article, and heating or heat-pressing the assembly so as to sublimate the nanoparticles from the transfer substrate on the article.

According to one preferred embodiment, the article is one of a garment and decorated media.

According to one preferred embodiment, the nanoparticles are selected from the group consisting of inorganic, carbon based, or metallic composition.

According to one preferred embodiment, the nanoparticles are quantum dots.

According to one preferred embodiment, the nanoparticles are of a size ranging from about 3 nanometers to about 500 nanometers.

According to one preferred embodiment, the method includes using nanoparticles pigment or dye-pigment embedded in a carrier matrix and wherein the step of depositing comprises of depositing a pattern of the carrier matrix on a transfer substrate. Preferably, the carrier matrix is selected from the group consisting of polymer, inorganic, organic, or metallic composition.

According to one preferred embodiment, the step of heating comprises heating the assembly to a temperature ranging from about 300 degrees Fahrenheit to about 450 degrees Fahrenheit.

According to one preferred embodiment, the step of heat-pressing comprises heat-pressing the assembly to a temperature ranging from about 100 degrees Fahrenheit to about 250 degrees Fahrenheit.

According to one preferred embodiment, the step of heating or heat-pressing further comprises placing the transfer substrate and article in an electric field ranging from about 10 Volts Direct Current to about 400 Volts Direct Current while at least one of heating and heat-pressing said transfer substrate and article.

In one aspect, a garment is disclosed which is colored by using nanoparticles pigment or dye-pigment as a coloring agent, depositing a pattern of them on a transfer substrate, drying the substrate, positioning the transfer substrate on a surface of the garment, and heating or press-heating the assembly so as to sublimate the nanoparticles from the transfer substrate on the garment.

In one aspect, a decorated media is disclosed which is colored by using nanoparticles pigment or dye-pigment as a coloring agent, depositing a pattern of them on a transfer substrate, drying the substrate, positioning the transfer substrate on a surface of the decorated media, and heating or press-heating the assembly so as to sublimate the nanoparticles from the transfer substrate on the decorated media.

In one aspect, a method for coloring an article is disclosed which includes using nanoparticles pigment or dye-pigment as a coloring agent and printing a pattern of them on the article.

According to one preferred embodiment, the article is one of a garment and decorated media.

According to one preferred embodiment, the method includes using nanoparticles pigment or dye-pigment embedded in a carrier matrix and wherein the step of printing comprises of printing a pattern of the carrier matrix on the article.

In one aspect, a garment is disclosed which is colored by using nanoparticles pigment or dye-pigment as a coloring agent and printing a pattern of them on the garment.

In one aspect, a decorated media is disclosed which is colored by using nanoparticles pigment or dye-pigment as a coloring agent and printing a pattern of them on the decorated media.

In one aspect, a method for coloring an article is disclosed which includes using a bulk material comprising nanoparticles pigment or dye-pigment as a coloring agent and either coloring the article by the bulk material or painting a pattern of the bulk material on the article.

In one aspect, a garment is disclosed which is colored by using a bulk material comprising nanoparticles pigment or dye-pigment as a coloring agent and either coloring the garment by the bulk material or painting a pattern of the bulk material on the garment.

In one aspect, a decorated media is disclosed which is colored by using a bulk material comprising nanoparticles pigment or dye-pigment as a coloring agent and either coloring the garment by the bulk material or painting a pattern of the bulk material on the decorated media.

### BRIEF DESCRIPTION OF THE DRAWINGS

FIG. 1 is a flow diagram of one preferred method of coloring an article utilizing nanoparticles.

FIG. 2 is a flow diagram of one preferred method of coloring an article utilizing nanoparticles.

FIG. 3 is a flow diagram of one preferred method of coloring an article utilizing nanoparticles.

FIG. 4 shows a perspective view of a T-shirt which maybe colored by any one of the methods shown in FIG. 1, 2, or 3, according to a preferred embodiment.

FIG. 5 shows a perspective view of a traffic sign which maybe colored by any one of the methods shown in FIG. 1, 2, or 3, according to a preferred embodiment.

### DETAILED DESCRIPTION OF THE PRESENTLY PREFERRED EMBODIMENTS

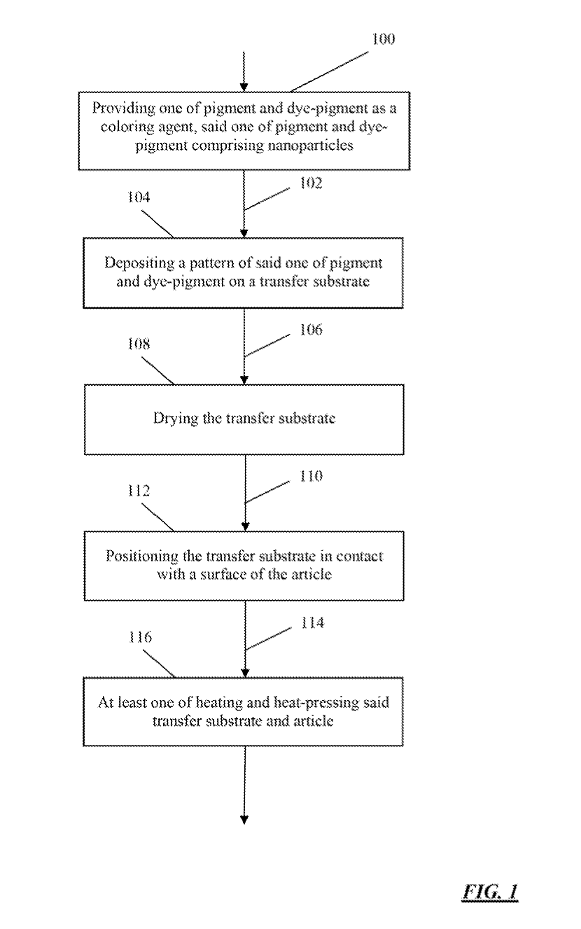

FIG. 1 is a flow diagram of one preferred method of coloring an article utilizing nanoparticles. The article maybe a garment or decorated media. According to this embodiment, the method comprises providing pigment or dye-pigment as a coloring agent, at 100, wherein the pigment or dye-pigment contains nanoparticles. The nanoparticles may be selected from the group consisting of inorganic, carbon based, or metallic composition. For instance quantum dots may be selected as the nanoparticles. The size of such nanoparticles may range from about 3 nanometers to about 500 nanometers.

The method continues at 102 and further includes the step of depositing a pattern of said one of pigment and dye-pigment on a transfer substrate at 104, known to artisans of ordinary skill. The method continues at 106 and further includes the step of drying the transfer substrate at 108. The method continues at 110 and further includes positioning the transfer substrate in contact with a surface of the article at 112. The method continues at 114 and concludes by either heating or heat-pressing the transfer substrate and article at 116, wherein the article and transfer substrate are jointly heated until the nanoparticles sublimate from the transfer substrate and are deposited on the article.

According to a preferred embodiment, the step 100 comprises providing either pigment or dye-pigment that are embedded in a carrier matrix and the step 104 comprises depositing a pattern of said carrier matrix on a transfer substrate. The carrier matrix may be selected from the group consisting of polymer, inorganic, organic, or metallic composition.

According to a preferred embodiment, the step 116 comprises heating the transfer substrate and article to a temperature which may range from about 300 degrees Fahrenheit to about 450 degrees Fahrenheit. In an alternative embodiment, the step 116 comprises heat-pressing the transfer substrate and article in a reduced pressure environment to a temperature which may range from about 100 degrees Fahrenheit to about 250 degrees Fahrenheit. In yet another preferred embodiment, the step 116 may further comprise placing the transfer substrate and article in an electric field which may range from about 10 VDC to about 400 VDC while either heating or heat-pressing the transfer substrate and article.

An application of this method will now be described. According to a preferred embodiment for the use of nanoparticles as a pigment, they are directly used as the coloring agent. Accordingly, the nanoparticles are printed onto a transfer substrate directly and allowed to dry thoroughly. The printed pattern of nanoparticles in then placed in contact with the target media to be colored and placed into an oven or heat press whereby the target media and the transfer substrate are jointly heated until the nanoparticles sublimate from the transfer substrate and are deposited onto the target media. This will typically occur in the range of 300-450° F. at atmospheric pressures, and the temperature to perform the thermal transfer can be reduced by 50-200° F. by placing the system into a vacuum oven or vacuum contained heat press.

The temperature to perform the transfer may alternatively be reduced by placing the target media and transfer substrate into an electric field. This may be accomplished by either addition of a positive and ground or negative electrode around the target media and transfer substrate within the heat press or heating oven, or by applying an electric field externally through the entire system, including the heat press, or vacuum oven. The former approach is preferred as it maximizes the field at the media and transfer substrate, which in turn maximizes the transfer efficiency. In this application, the nanoparticles are directly transferred to the target media and upon excitation with the appropriate wavelength (typically in the near UV) or upon electro-excitation through means of an electric current being provided to the particle pattern through either conductive wires or fibers embedded within the target media or externally through conductive wires or fibers above or below the surface of the target media, will emit light in the desired pattern from the substrate through photo- or electro-luminescence, respectively. The particles in this case may typically be from 5-50 nm in size, and the wavelength of emitted light will be tunable for a given material by adjusting the size of the particles being used for the pigmentation.

In addition several sizes of particles may be used together or separately to create patterns or blended emission, similar to inkjet printing where colors of ink are blended to create a wider full range of available colors to print. The nanoparticles may be dispersed onto the transfer substrate by any means, but common examples of how they might be patterned would be through manual placement or painting of a solution of nanoparticles, through inkjet printing of a solution of particles, through spin-coating, or through dry printing (i.e. processing similar to laser printing).

An alternative application of this method will now be described. The method utilizes nanoparticles as a dye pigment similar to above except that instead of pure nanoparticle material being used as the pigment, the nanoparticles are first embedded into a carrier matrix and then deposited onto the transfer substrate. This combination may be designed to improve the lifetime and protect the nanoparticles against photo or electro bleaching, or to improve the transfer efficiency of the pigment or nanoparticles from the transfer substrate onto the target media. The combination of embedded nanoparticles and the carrier matrix can either be created separately or concurrently with the printing or deposition of the combined particles onto the transfer substrate.

For the case where the combination is created separately, the nanoparticles would typically either be attached to the surfaces of particles of the carrier matrix, typically in the range of 50-500 nm in size, through a chemical reaction. The surface of the nanoparticle can be modified to enable surface chemical groups that will be reactive with the carrier substrate material to facilitate this process. Once combined with the carrier matrix, the nanoparticle and carrier matrix combined particle can be printed, disbursed, and blended with other combinations of either pure nanoparticles or nanoparticle/matrix mixtures for transfer to a target substrate as described previously. Alternatively, the nanoparticle can be wholly incorporated into the carrier matrix, either during formation of the matrix (as in the case of polymerization of a carrier polymer particle), or by dissolving into the substrate, if the mobility of the nanoparticle is sufficiently high to be absorbed by the carrier. The latter case may involve heating of the carrier matrix in a solution of nanoparticles to be incorporated to a temperature of 200-500F.

After the nanoparticle is incorporated into the carrier substrate, the combination may be pulverized to create particles typically of target sizes from 50-500 nm that can be applied, disbursed, and blended for transfer onto a substrate as described above. Combining the nanoparticles into a carrier matrix is often beneficial to ensure the particles are better protected from the decomposition and structural changes that can lead to photo-and-electro-bleaching, which is a process by which the emission efficiency of the pigment decreases over time due to deterioration of the quality of the pigment. This process typically occurs over 0.5-6 years, and can be extended by a factor of 2 or more upon incorporation into a substrate, but the full benefit depends on each system that is used for pigmentation and carrier matrix.

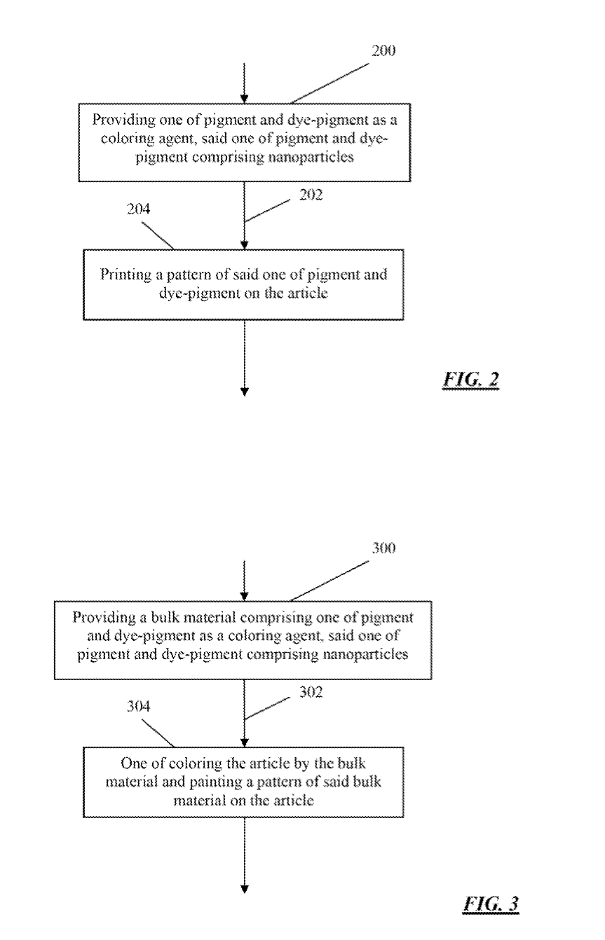

FIG. 2 is a flow diagram of one preferred method of coloring an article utilizing nanoparticles. The article maybe a garment or decorated media. According to this embodiment, the method comprises providing pigment or dye-pigment as a coloring agent, at 200, wherein the pigment or dye-pigment contains nanoparticles. As stated above, the nanoparticles may be selected from the group consisting of inorganic, carbon based, or metallic composition. For instance quantum dots may be selected as the nanoparticles. The size of such nanoparticles may range from about 3 nanometers to about 500 nanometers.

The method continues at 202 and further includes the step of printing a pattern of the pigment or dye-pigment on the article at 204. Accordingly, direct printing, either through a process similar to screen printing, or through direct printing of a pigmented media to a target media substrate can be accomplished. According to this preferred embodiment, no transfer substrate is needed, and the nanoparticle pigment is directly applied to the target media, such as a T-shirt or traffic sign, discussed in more detail below.

As stated in connection with sublimation process above, the pigmentation may be either pure nanoparticles or a combination of nanoparticles incorporated into a carrier matrix, and the pigmentation may be permanently affixed to the target media either through evaporative, thermal, or polymerization of the mixture applied. For instance, in evaporative bonding, the nanoparticle or nanoparticle/carrier matrix mixture applied is designed to form a chemical bond to the target media and reacts with the media surfaces to retain the desired pattern. Additionally, as stated above, the media can be mixed or blended to give a wider variety of wavelengths and patterns. In thermal bonding, the reaction of the pigmentation mixture may require heat to react with the target media, and upon exposure to heat, the mixture becomes permanently affixed to retain the desired patterns. For the case of polymeric adhesion, this is most similar to existing screen printing, whereby the mixture of pigment and polymer precursors is cured to the target media by way of a polymeric reaction where the precursors bond to the target media surface and trap the nanoparticle or nanoparticle/carrier matrix pigment in place.

It is important to note here that the nanoparticle and/or carrier matrix used in combination for the pigmentation may or may not be made up of the same materials as the polymer media used to bond the pigment to the target media, and also that the polymer media may be conductive or non-conductive with embedded conductive fibers or wires to allow for electro-luminescence if desired. Typical materials for polymeric bonding would be plastisol or other PVC based materials used currently in garment screen printing techniques.

FIG. 3 is a flow diagram of one preferred method of coloring an article utilizing nanoparticles. The article maybe a garment or decorated media. According to this embodiment, the method comprises providing a bulk material including either pigment or dye-pigment as a coloring agent at 300, wherein the pigment or dye-pigment comprises nanoparticles. As stated above, the nanoparticles may be selected from the group consisting of inorganic, carbon based, or metallic composition. For instance quantum dots may be selected as the nanoparticles. The size of such nanoparticles may range from about 3 nanometers to about 500 nanometers.

The method continues at 302 and further includes the step of either coloring the article by the bulk material or painting a pattern of said bulk material on the article at 304. Accordingly, the nanoparticles or nanoparticle/carrier substrate is added to a mixture of solvent or solvent free liquid (for example, paint, stain, or other sealant or mixture used for coloring and/or sealing a surface) that is applied to a broad surface either through brushing, spraying, or other typical applications used for painting or sealing surfaces.

The pigment is used in the same way as current colorants are used, but is unique in that the color spectrum available is defined by the size of the particle selected and how different sizes or particles are mixed, either as a pure material additive or as added in combination with a carrier substrate. The nanoparticle or nanoparticle/carrier matrix pigment may be used separately as described above, or in combination with current pigments, paints, sublimation dyes, or other existing colorants to provide a layered or complementary pattern to the target media substrate.

This mixing can be done in situ, with the nanoparticle based pigment added directly to the classical pigment, or preferably through an overlay printing technique whereby a first pattern is created using the classical technique and a second, complementary pattern is created using the nanoparticle based pigments. This can be done through simultaneous printing, for example using an inkjet printer with different ink wells, or by subsequent processing, for example using a different screen to overlay/interleave screen printed designs.

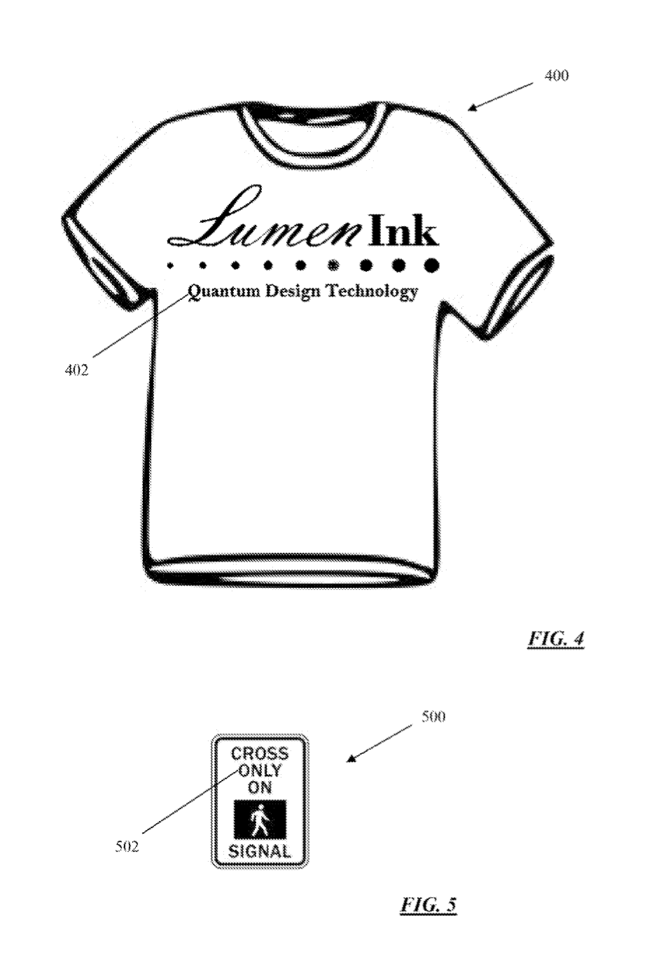

FIG. 4 shows a perspective view of a T-shirt 400 which maybe colored by any one of the methods discussed in connection with FIG. 1, 2, or 3, according to a preferred embodiment. The T-shirt 400 has been colored by a mark 402 which comprises the phrase LUMENINK QUANTUM DESIGN TECHNOLOGY which may include the color(s) red, yellow, green, blue, orange, pink, dark blue, light blue, black, and white.

The mark 402 comprises the phrase LUMEN INK whose color ranges from pink to black and which includes the colors red, yellow, green, light green, blue, orange, pink, dark blue, light blue, black, and white. The mark 402 further includes 9 circles of increasing diameter and whose colors range from blue to red which includes the colors dark blue, light blue, blue, green, light green, yellow, orange, pink, and red. The mark 402 further includes the phrase QUANTUM DESIGN TECHNOLOGY whose color may include the color black.

FIG. 5 shows a perspective view of a traffic sign 500 which maybe colored by any one of the methods discussed in connection with FIG. 1, 2, or 3, according to a preferred embodiment. The traffic sign 500 has been colored by a mark 502 which comprises the phrase CROSS ONLY ON SIGNAL which may include the color black. The mark 502 further includes an image of a drawing portraying a walking individual in white color against a black background.

The foregoing discloses processes for coloring an article using nanoparticles, such as quantum dots, as pigment or dye-pigment, via dye-sublimation, printing, coloring, or painting methods. Garments or decorative media can be manufactured using these methods.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A method for coloring an article, comprising:
(a) providing one of pigment and dye-pigment as a coloring agent, said one of pigment and dye-pigment comprising nanoparticles;
(b) depositing a pattern of said one of pigment and dye-pigment on a transfer substrate;
(c) drying the transfer substrate;
(d) positioning the transfer substrate in contact with a surface of the article; and
(e) at least one of heating and heat-pressing said transfer substrate and article;
wherein the article and transfer substrate are jointly heated until the nanoparticles sublimate from the transfer substrate and are deposited on the article.

2. The method of claim 1, wherein the article is one of a garment and decorated media.

3. The method of claim 1, wherein the nanoparticles are selected from the group consisting of inorganic, carbon based, or metallic composition.

4. The method of claim 1, wherein the nanoparticles are quantum dots.

5. The method of claim 1, wherein the nanoparticles are of a size ranging from about 3 nanometers to about 500 nanometers.

6. The method of claim 1, wherein the step (a) comprises providing one of pigment and dye-pigment embedded in a carrier matrix and wherein the step (b) comprises depositing a pattern of said carrier matrix on a transfer substrate.

7. The method of claim 6, wherein the carrier matrix is selected from the group consisting of polymer, inorganic, organic, or metallic composition.

8. The method of claim 1, wherein the step (e) comprises heating said transfer substrate and article to a temperature ranging from about 300 degrees Fahrenheit to about 450 degrees Fahrenheit.

9. The method of claim 1, wherein the step (e) comprises heat-pressing said transfer substrate and article in a reduced pressure environment to a temperature ranging from about 100 degrees Fahrenheit to about 250 degrees Fahrenheit.

10. The method of claim 1, wherein the step (e) further comprises placing said transfer substrate and article in an electric field ranging from about 10 VDC to about 400 VDC while at least one of heating and heat-pressing said transfer substrate and article.

11. A garment colored by the method of claim 1.

12. A decorated media colored by the method of claim 1.

13. A method for coloring an article, comprising:
(a) providing one of pigment and dye-pigment as a coloring agent, said one of pigment and dye-pigment comprising nanoparticles; and
(b) printing a pattern of said one of pigment and dye-pigment on the article.

14. The method of claim 13, wherein the article is one of a garment and decorated media.

15. The method of claim 13, wherein the step (a) comprises providing one of pigment and dye-pigment embedded in a carrier matrix and wherein the step (b) comprises printing a pattern of said carrier matrix on the article.

16. A garment colored by the method of claim 13.

17. A decorated media colored by the method of claim 13.

18. A method for coloring an article, comprising:
(a) providing a bulk material comprising one of pigment and dye-pigment as a coloring agent, said one of pigment and dye-pigment comprising nanoparticles; and
(b) one of coloring the article by the bulk material and painting a pattern of said bulk material on the article.

19. A garment colored by the method of claim 18.

20. A decorated media colored by the method of claim 18.
